(19) United States
(12) Patent Application Publication
(10) Pub. No.: US 2005/0152575 A1
(43) Pub. Date: Jul. 14, 2005

(54) Loudspeaker transducer

(76) Inventor: Paul W. Paddock, McMinnville, OR (US)

Correspondence Address: Glenn C. Brown, P.C., 777 N.W. Wall Street, Suite 308, Bend, OR, 97701, US

(21) Appl. No.: 10/909,231

(22) Filed: Jul. 29, 2004

Related U.S. Application Data
(63) Continuation of application No. PCT/US02/01319, filed on Jan. 14, 2002.

(51) Int. Cl. H04R 1/00; H04R 9/06

(52) U.S. Cl. 381/421; 381/423

(57) ABSTRACT

The present invention is embodied in an audio transducer that exhibits excellent audio characteristics. The present invention includes a single, curved planar diaphragm that is mounted at its driven end between a pair of spaced-apart linear magnets. The diaphragm is curved in an asymmetric shape similar to that of a curved resilient spring. i.e. the radius of curvature of the diaphragm increases continually along the length of the diaphragm. The speaker of the present invention exhibits excellent characteristics when mounted to a flat surface such as a wall, making it particularly well-suited for use in video applications.

### CROSS-REFERENCE TO RELATED APPLICATION

This application is a continuation of PCT patent application No. PCT/US2002/01319, filed on Jan. 14, 2002. The priority of the prior application is expressly claimed and its disclosure is hereby incorporated by reference in its entirety.

### TECHNICAL FIELD

This invention is related to audio transducers, and in particular to a novel audio transducer design that exhibits unusually good efficiency, frequency response, and accuracy.

### FIELD OF THE INVENTION

My earlier patent, U.S. Pat. No. 5,320,021, discloses an audio transducer in which a pair of symmetric diaphragms are mounted on a frame and driven by a pair of spaced apart magnets. These audio transducers exhibit excellent sound qualities, and also offer flexibility and economy in the manufacturing process. However, they incorporate multiple diaphragms and the required corresponding structure.

### SUMMARY OF THE INVENTION

An object of this invention, therefore, is to provide an improved transducer featuring a construction which overcomes the difficulties and shortcomings indicated.

More specifically, an object of the invention is to provide a transducer with an improved high frequency response without a loss of efficiency or performance.

Another object of the invention is to provide a high performance transducer that may be inexpensively manufactured, having a small number of parts and requiring few complex manufacturing processes.

A further object of the invention is to provide a transducer having a rigid moving mass of reduced weight.

Yet another object of the invention is to provide a transducer wherein the diaphragm may be easily and precisely aligned within the magnet gap to safely permit a narrowed magnet gap such that the alignment remains fixed over use and time.

It is a further object of the invention to provide a transducer with a diaphragm alignment system that does not add appreciable mass to the transducer and which is sufficiently lightweight to avoid damping the vibration of the diaphragm.

A further object of the invention is to provide a transducer having a diaphragm alignment system that distributes suspension forces equally along the length of the diaphragm.

It is a further object of the invention to provide a transducer having a rigid magnet alignment structure that does not limit the width of the diaphragm employed.

A further object of the invention is to provide a transducer with a diaphragm constructed from a material that has a high strength-to-weight ratio, is resistant to solvents and acids, which resists degradation on exposure to ultraviolet radiation, which has a surface that is compatible with a wide variety of standard adhesives, and which is highly thermally transmissive without warpage at high temperatures and temperature differentials.

These and other objects and advantages of the invention will become more fully apparent as the description which follows is read in conjunction with the accompanying drawings.

The present invention is embodied in an audio transducer that exhibits excellent audio characteristics. The present invention includes a single, curved planar diaphragm that is mounted at its driven end between a pair of spaced-apart magnets. The diaphragm is curved in an asymmetric shape similar to that of a curved resilient spring, i.e. a cross-sectional view of the diaphragm shows the edge of the diaphragm as a sort of spiral where the radius of curvature increases continually along the length of the diaphragm.

The foregoing and other objects, features and advantages of the invention will become more readily apparent from the following detailed description of a preferred embodiment which proceeds with reference to the drawings.

### BRIEF DESCRIPTION OF THE DRAWINGS

FIG. 1 is a perspective view of a diaphragm according to a preferred embodiment of the invention.

FIG. 2 is a top schematic view of a preferred embodiment of the invention showing the arrangement of the diaphragm and the magnets.

FIG. 3 is a top schematic view of a preferred embodiment of the invention showing the arrangement of the diaphragm and the magnets, and also showing the optimal radiating angles.

FIG. 4 is a cross-sectional view of the magnets comprising the linear drivers in a preferred embodiment.

FIG. 5 is a top schematic view of the embodiment shown in FIG. 2, and showing the suspension and centering apparatus.

FIG. 6 is a side cross sectional view of the suspension and centering system.

FIG. 7 is a side view of the diaphragm showing the diaphragm with the attached voice coil and the damping strips that in this instance, extend to near the distal end of the diaphragm.

FIG. 8 is a top view of the mounting plate showing the tube stays.

FIG. 9 is a top view of the mounting plate shown in FIG. 8 and also showing the magnet assemblies and diaphragms mounted therein, and in particular showing the distal end of the diaphragm adhered to one of the tube stays by means of two sided tape.

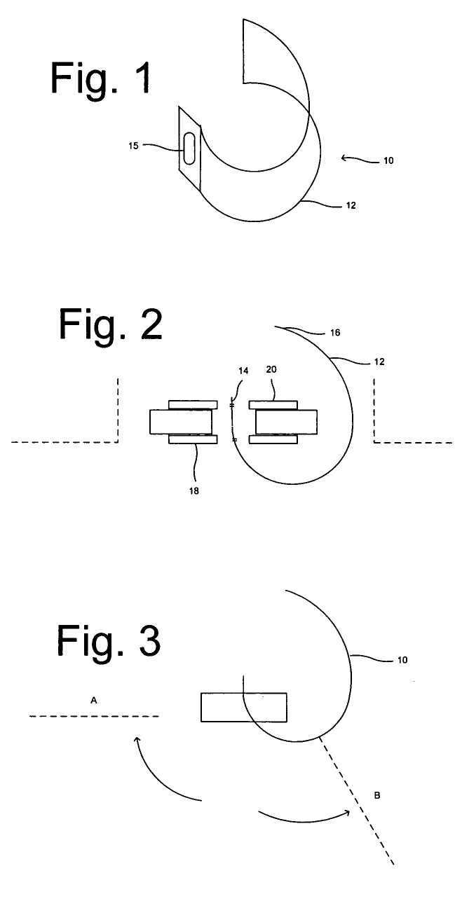

### DETAILED DESCRIPTION OF THE PREFERRED EMBODIMENT

Referring to FIG's. 1-4, a preferred embodiment of the invention is shown at 10. The audio transducer includes a curved diaphragm 12 having a driven end 14 and a dampened end 16. The diaphragm 12 can be thought of as a rectangular planar member with the driven end 14 mounted between a pair of spaced-apart magnets 18 and 20 that in part form the driver. A flat, rectangular voice coil 15 is mounted on the driven end 14, and is either adhered or mechanically attached to the driven end 14 of the diaphragm to form the diaphragm assembly 17. (See FIG. 2). The voice coil 15 and driven end 14 are suspended within the magnetic gap in such a manner that a back and forth motion is initiated in step with an applied audio voltage.

In the preferred embodiment, the driver includes magnets 18 and 20 that extend along and are co-extensive with the driven end 12 of diaphragm assembly 17. This structure is referred to as a “linear driver”, and was described in detail in my earlier patent U.S. Pat. No. 5,320,021, the specification of which is hereby incorporated by reference. To maximize speaker efficiency, the magnet gap should be as narrow as possible while allowing sufficient clearance to permit passage of a planar diaphragm 46 as will be discussed below. The ideal gap width varies depending on the size of the transducer and application being fulfilled. The magnet gap 40 may range between 0.020 and 0.062 inch, with a spacing of inch being preferred in the particular high frequency transducer 20 illustrated.

As shown in FIG. 5, each magnet assembly 36, 38 comprises a magnetic core, 48, 50, respectively, with a pair of rigid, ferro-magnetic metal pole plates 52 affixed to the opposite sides of each magnetic core. The pole plates 52 are generally coextensive with the magnetic cores 48, 50, extending slightly beyond the magnetic cores in the direction of the magnet gap 40 so that the separation between opposed pole plates 52 defines the magnet gap. The magnetic cores 52 are magnetically oriented so that each pole plate is of opposite magnetic polarity from the other pole plate attached to the same magnetic core and so that each pole plate 52 is also magnetically opposite from its counterpart across the magnet gap 40.

The diaphragm assembly is mounted and centered in the driver assembly as follows. The end portion of the diaphragm includes damping strips adhered thereto. A series of holes are drilled or stamped in their predetermined locations to align with the centering tabs as shown in FIG. 6. The holes are sized to allow reliable registry with and entry of the pointed tabs and adhering thereto. The voice coil is wound of wire as previously described on an aluminum foil strip. This assembly is laminated to the plastic diaphragm between the two strips of vertical holes. The damping strips are provided to control unwanted oscillation of the diaphragm.

The diaphragm is centered by means of a suspension centering system that functions as follows. The centering tabs are aligned vertically along one side of the front and back of the magnet structure only. The tabs are tapered to a point to allow them to enter the matching holes in the diaphragm. The tabs are affixed by glue so that the diaphragm is centered in relation to the magnetic gap. The vertical strips of foam tape spaces the tabs away from the magnetic structure allowing free lateral motion of the diaphragm into and out of the magnetic gap. In alternative embodiments, the tabs could be cast in a comb like structure as well. The foam tape is a commercially available double sided tape of cellulose urethane. The tabs can be formed of any of a number of flexible films or papers, and none in particular demonstrates any clearly superior performance. Elongation of the tabs is not required, eliminating an onerous problem often encountered in manufacturing. The amount of tabs, their spacing, the amount of free length, their shape can be determined to most readily accommodate ease of manufacture.

The diaphragm 12 extends from between the magnets and curves asymmetrically to position the opposite dampened end 16 of the diaphragm to the side and behind the magnets and driven end 12. The curvature of the diaphragm was determined experientially to yield the broadest, flattest frequency response. In one preferred embodiment, the curvature is that of a tensioned spring, and which can be generally described as having an initial radius adjacent to the driven end 14, and in which the radius increases along the curvature of the diaphragm to its dampened end.

The dampened end 16 of diaphragm 12 is mounted in the frame assembly 13 as shown in FIG. 6. The driver and diaphragm assembly are mounted in a frame assembly 13, which in turn is mounted in an enclosure (not shown). In one embodiment, a frame includes top and bottom members that are shaped in the same general shape as the diaphragm, only larger. The frame members are slotted to receive the magnetic blocks, and are spaced apart by 2 or three vertical members, allowing for as much open frame width as possible. Holes are let into the plates' central to the tube stays to allow vertical stacking of multiple transducers into a large assembly using a long threaded rod.

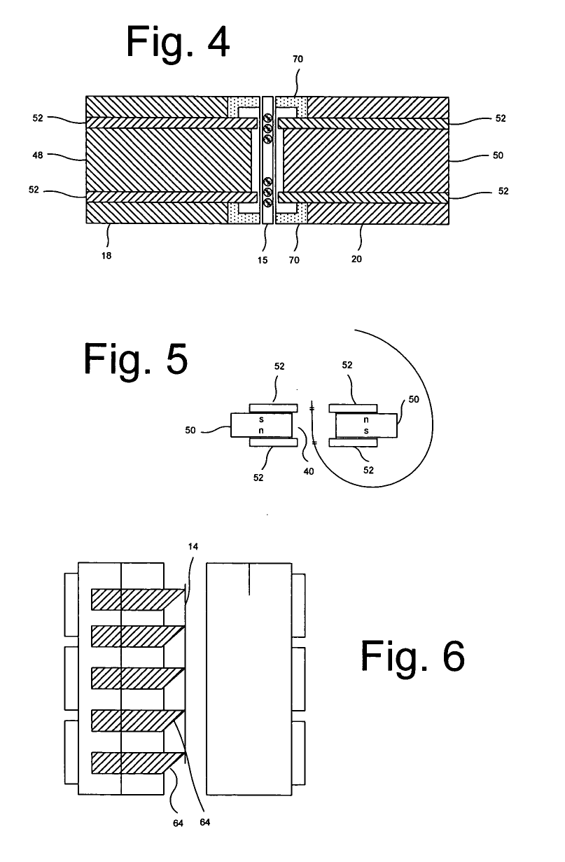

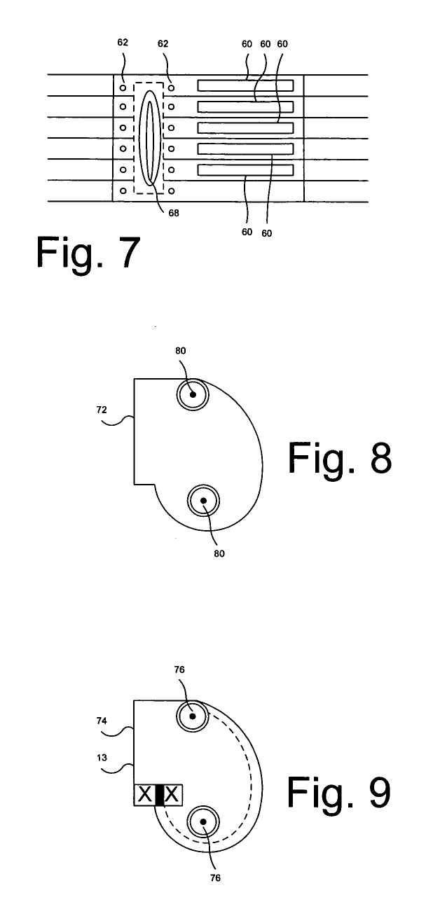

In operation, an audio signal is applied to the linear driver in a conventional fashion. The voice coil 15 is oscillated back and forth in the magnetic gap of the linear driver, vibrating the diaphragm driven end 14. This physical motion travels through the diaphragm and expends some of its energy as sound. The primary radiation area is across an angle extending from a plane tangent to the magnet structure to about 90 degrees to 120 degrees. (See FIG. 4). The device maintains its flat power output over this broad angle. It can also be seen that this is an asymmetric device and is unique in that regard. Initial tests were performed with assemblies having a diaphragm 6″ high by 4″ wide by 6″-8″ deep. These devices exhibited a frequency response exceeding 5 octaves with an essentially flat output, i.e. within a 3 db range from 500 hz to 18 khz. This indicates unusually good transient response with very low coloration.

In another aspect of the invention, unlike other speaker designs the device actually benefits from being placed in a wall surface such as the dotted line represented by ‘A’ in FIG. 4. This presents a perfect half-plane environment over the midrange and top end yielding very smooth response in this difficult application. It is anticipated that the present invention is therefore well suited to “in wall” mounting, to mounting in a television enclosure, and in particular to incorporation with “flat panel” television units.

Having illustrated and described the principles of my invention in a preferred embodiment thereof, it should be readily apparent to those skilled in the art that the invention can be modified in arrangement and detail without departing from such principles. I claim all modifications coming within the spirit and scope of the accompanying claims.

1. An audio transducer comprising:
a flexible diaphragm having a first end portion, a second end portion, and;
an arcuate radiating surface there between;
a voice coil operatively engaged with the first end portion of the diaphragm;
first and second spaced-apart magnets defining a gap and a first axis there between;
the voice coil and first end portion of the diaphragm disposed in the gap between the first and second magnets, and;
the voice coil and second end portion of the diaphragm operatively disposed in the gap.

2. An audio transducer according to claim 1 further comprising the voice coil first and second magnets being elongate magnets.

3. An audio transducer according to claim 1 further comprising the voice coil first and second magnets being elongate magnets having a length that is coextensive with the planar member first end.

4. An audio transducer according to claim 1 further comprising the voice coil first and second magnets having a dimension that is at least coextensive with the planar member first end.

5. An audio transducer according to claim 1 further comprising the voice coil first and second magnets being generally circular and having a diameter that is at least coextensive with the planar member first end.

6. An audio transducer according to claim 1 wherein the diaphragm the arcuate radiating surface of the diaphragm having a radius that increases with increasing angular displacement of the radiating surface relative to the first axis.
